(19) United States
(12) Patent Application Publication
(10) Pub. No.: US 2015/0338500 A1
(43) Pub. Date: Nov. 26, 2015

(54) MEASUREMENTS REPORT QUALITY OF POSITION VALIDATION UNDER MOBILE STATION-ASSISTED MODE OF OPERATION

(71) Applicants: Tirosh LEVIN, Hadera, M (IL); Chandru ASWANI, (US); Saket S. JHA, Bangalore, KA (IN)

(72) Inventors: Tirosh Levin, Hadera, M (IL); Chandru Aswani, Bangalore, KA (IN); Saket S. Jha, Bangalore, KA (IN)

(21) Appl. No.: 14/359,901

(22) PCT Filed: Dec. 18, 2013
(86) PCT No.: PCT/US2013/076239

§ 371 Date: May 21, 2014

(51) Int. Cl. G01S 5/00; H04W 64/00; G01S 19/42

(52) U.S. Cl. CPC G01S 5/0027; G01S 19/42; H04W 64/006

(57) ABSTRACT

Embodiments of the present disclosure are directed towards devices and methods for measurement report Quality of Position (QoP) validation in mobile station or mobile device (MS)-Assisted GNSS position systems. In one embodiment, a QoP value is calculated at a mobile device and a requested measurement report is only sent to a network server if the calculated QoP value exceeds a threshold value. In another embodiment, the QoP threshold value is included in the request for measurement report.

### FIELD

Embodiments of the present disclosure generally relate to the field of position measurement of mobile devices, and more particularly, methods and apparatuses for more efficient position measurement in mobile station assisted (MS-assisted) measurement systems.

### BACKGROUND

Mobile devices often have global navigation satellite system (GNSS) capabilities to determine the location of the device. These capabilities are used for a number of purposes including position measurement for emergency response. MS-assisted measurement systems rely upon data received directly at the mobile device from satellites, as well as data received via a network to determine the position of the mobile device. These systems also allow position calculations to be performed at network servers rather than locally at the mobile device, potentially saving power and computational resources. To facilitate these remote position calculations, mobile devices must gather data and transmit it to the remote server via the network. In some instances the data provided from the mobile device to a network server does not adequately support accurate position calculations. When this occurs, it may be necessary to gather and transmit additional data to ensure an accurate position can be calculated. Such repeated transmission of data from the mobile device to the network server wastes mobile device power, computing resources and communication bandwidth.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 schematically illustrates a system used in mobile device assisted (MS-assisted) measurements.

FIG. 2 schematically illustrates a mobile device in accordance with some embodiments.

FIG. 3a illustrates a portion of a method for making an MS-assisted position measurement, in accordance with some embodiments.

FIG. 3b illustrates a portion of a method for making an MS-assisted position measurement, in accordance with some embodiments.

FIG. 4 schematically illustrates an example system that may be used to practice various embodiments described herein.

### DETAILED DESCRIPTION

Embodiments of the present disclosure describe methods and apparatuses for more efficient position measurement in mobile station or mobile device assisted (MS-assisted) measurement systems. These embodiments are designed to ensure that the data provided from a mobile device to a network server in response to a request for measurement report will meet Quality of Position (QoP) objectives.

In the following description, various aspects of the illustrative implementations will be described using terms commonly employed by those skilled in the art to convey the substance of their work to others skilled in the art. However, it will be apparent to those skilled in the art that embodiments of the present disclosure may be practiced with only some of the described aspects. For purposes of explanation, specific numbers, materials and configurations are set forth in order to provide a thorough understanding of the illustrative implementations. However, it will be apparent to one skilled in the art that embodiments of the present disclosure may be practiced without the specific details. In other instances, well-known features are omitted or simplified in order not to obscure the illustrative implementations.

In the following detailed description, reference is made to the accompanying drawings which form a part hereof, wherein like numerals designate like parts throughout, and in which is shown by way of illustration embodiments in which the subject matter of the present disclosure may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” “in embodiments,” or “in some embodiments,” which may each refer to one or more of the same or different embodiments. Furthermore, the terms “comprising,” “including,” “having,” and the like, as used with respect to embodiments of the present disclosure, are synonymous.

The term “coupled with” along with its derivatives, may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. The term “directly coupled” may mean that two or more elements are in direct contact.

As used herein, the term “circuitry” refers to, is part of, or includes hardware components such as an Application Specific Integrated Circuit (ASIC), an electronic circuit, a logic circuit, a processor (shared, dedicated, or group) and/or memory (shared, dedicated, or group) that are configured to provide the described functionality. In some embodiments, the circuitry may execute one or more software or firmware programs to provide at least some of the described functionality.

As used herein, the term “module” may refer to, be part of, or include an Application Specific Integrated Circuit (ASIC), an electronic circuit, a system-on-chip (SoC), a processor (shared, dedicated, or group) and/or memory (shared, dedicated, or group) that execute one or more software or firmware programs, a combinational logic circuit, and/or other suitable components that provide the described functionality.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation

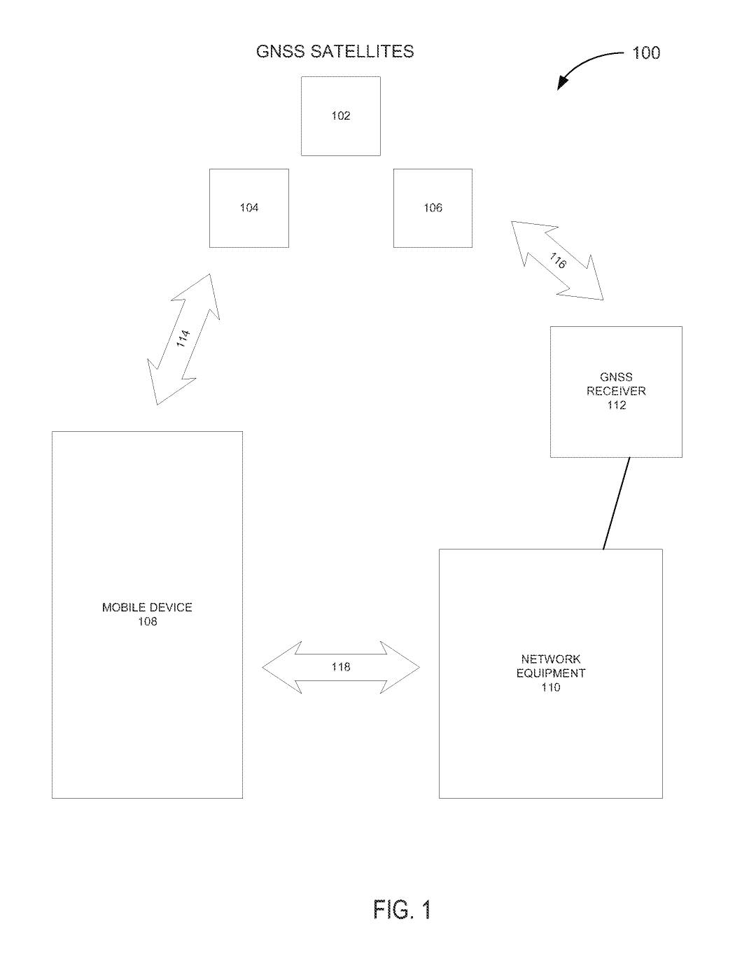

FIG. 1 schematically illustrates a system 100 used in MS-assisted measurements. The system 100 may include GNSS satellites 102, 104, 106 that provide data to remote receivers. The remote receivers may include a mobile device 108 that receives data from the GNSS satellites 102, 104, 106, as shown by arrow 114. The remote receivers may further include a GNSS receiver 112 that receives data from the GNSS satellites 102, 104, 106, as shown by arrow 116. The GNSS receiver 112 may be connected to network equipment 110. Although shown as a separate component, the GNSS receiver 112 may be located with, or incorporated into, the network equipment 110. Network equipment 110 may include network servers, base stations, antennas, WiFi equipment and other communications infrastructure. Network equipment 110 may include a node of a network and may also include circuitry for generating a request for measurement report as well as circuitry for transmitting a request for measurement report to a mobile device over a network.

Mobile device 108 may communicate with network equipment 110 as shown by arrow 118. Arrow 118 may represent any communications link including, but not limited to, shorter range wireless communications such as Wi-Fi and Bluetooth, as well as longer range wireless communications such as enhanced data rates for GSM evolution (EDGE), general packet radio service (GPRS), code division multiple access (CDMA), worldwide interoperability for microwave access (WiMAX), long term evolution (LTE), enhanced voice-data optimized (Ev-DO), and others.

In MS-assisted measurement systems a mobile device 108 receives data from network equipment 110 to assist in position measurement. The information received from the network may facilitate the identification of satellites with which the mobile device 108 may communicate as well as provide additional information that may facilitate both gathering position information and calculating a position. As such, the amount of information that the mobile device 108 must gather directly from the GNSS satellites 102, 104, 106 can be limited and the time required to collect the necessary data may be reduced. Additionally, it may be possible to perform some calculations at the network equipment 110, thus limiting the use of computational resources at the mobile device 108.

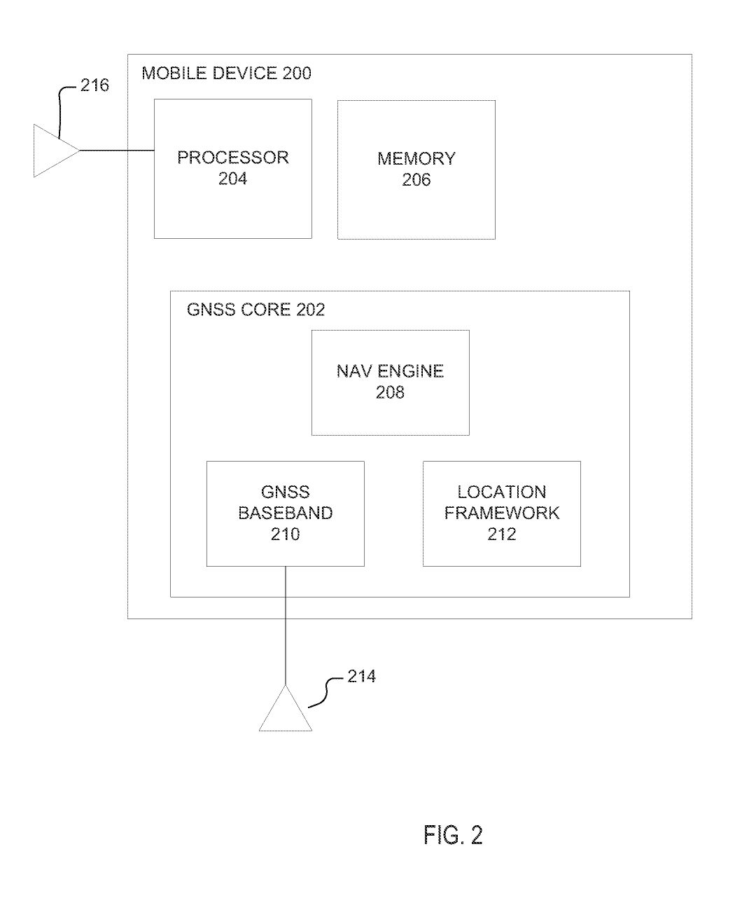

FIG. 2 illustrates a mobile device 200 (such as mobile device 108 in FIG. 1) in accordance with some embodiments. Mobile device 200 may be a mobile phone, a tablet, or any other GNSS-capable mobile device. Mobile device 200 may contain one or more processors 204. Processors 204 may include single-core and/or multi-core processors. The processors 204 may include any combination of general-purpose processors and dedicated processors (e.g., graphics processors, application processors, baseband processors, etc.).

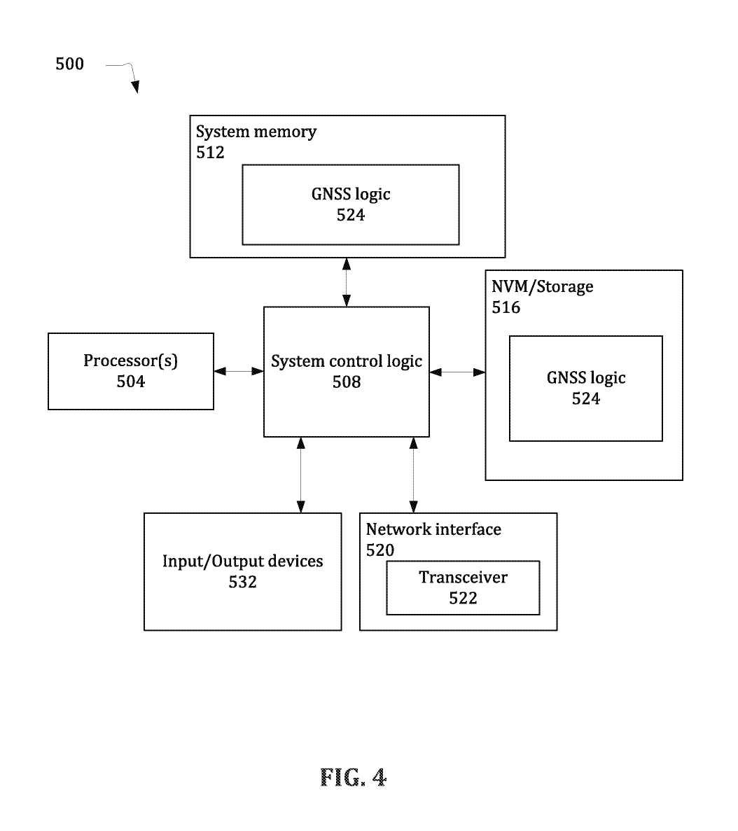

Processors 204 may incorporate an applications processor, a graphics processor, and a modem (such as an LTE modem) or any combination of such elements. In one embodiment, processors 204 may include an Intel® XMM™ 7160 chip. Processors 204 may include circuitry for generating a request for measurement report as well as circuitry for sending a request for measurement report to other modules and/or circuitry within the mobile device 200 for processing. Processors 204 may be attached to an antenna 216 for communicating over a network (such as with network equipment 110 in FIG. 1). Antenna 216 may facilitate communication via any known protocol, such as those discussed above. Memory 206 may be any suitable form of memory as discussed in more detail with regards to FIG. 4 below.

Mobile device 200 may also contain a global navigation satellite system core 202 (GNSS core). The GNSS core 202 may contain a NAV engine 208, a GNSS baseband 210, and a Location Framework 212. The NAV engine 208 may be operable to control the GNSS baseband 210. The NAV engine 208 may further be operable to perform calculations such as measuring and comparing quality indicators as well as determining position and Quality of Position (QoP) based on data received from GNSS baseband 210. The NAV engine 208 may include circuitry or one or more modules to perform these and other functions. GNSS baseband 210 may be operable to acquire and track GNSS satellites (such as GNSS satellites 102, 104, 106 in FIG. 1). GNSS baseband 210 may be connected to a GNSS antenna 214 for receiving information from GNSS satellites (such as GNSS satellites 102, 104, 106 in FIG. 1). GNSS baseband 210 may also be operable to generate a measurement report including pseudo-ranges and quality indicators based on data received from GNSS satellites. GNSS baseband 210 may also be operable to receive and parse data blocks from GNSS satellites. The GNSS baseband 210 may include circuitry or one or more modules to perform these and other functions.

Location framework 212 may communicate with processors 204 to receive incoming requests for measurement or other data received by the processors 204 via antenna 216. The location framework 212 may include circuitry or one or more modules to perform these and other functions. While each component is shown independently it may be possible to combine the components or to provide the functionality of components via specialized circuitry or via programming of one or more general purpose processors (such as processors 204). For instance, in some embodiments it may be possible for the GNSS core components to be combined with the processors 204. In some embodiments one or more of the GNSS core components may reside on the same circuit or chip with circuitry or modules providing modem functionality.

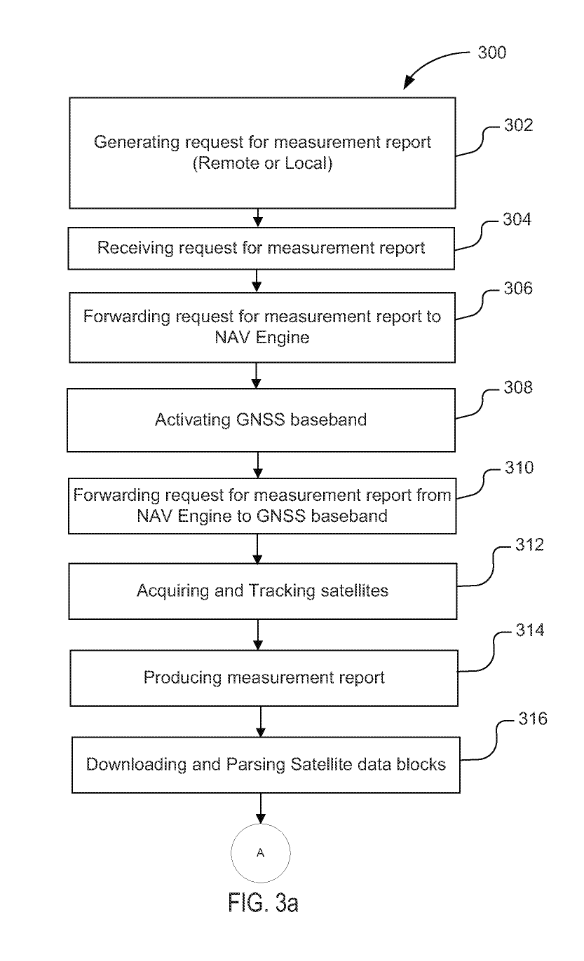

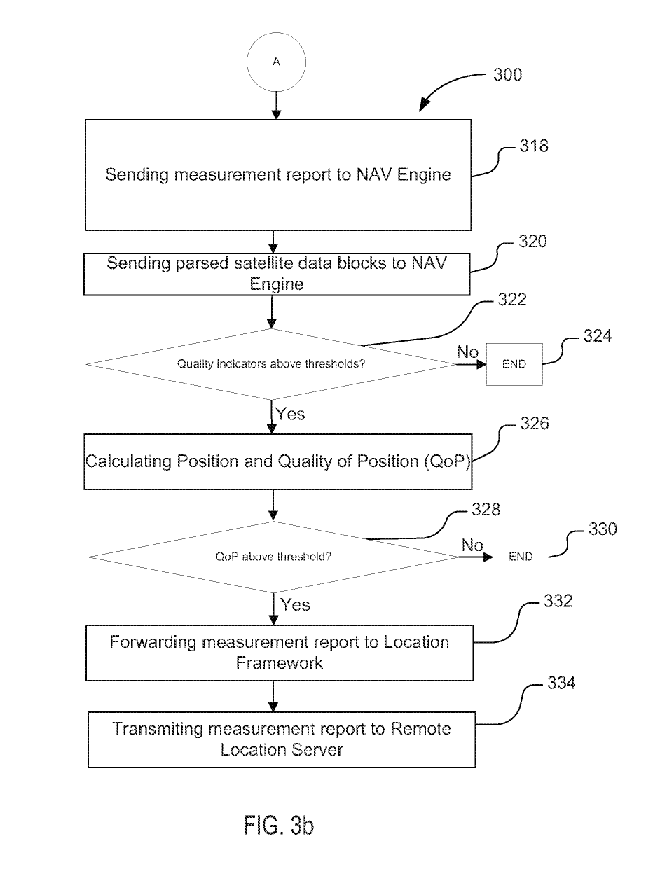

FIGS. 3a and 3b illustrate a method 300 for making an MS-assisted position measurement, in accordance with some embodiments. In various embodiments, the method 300 may be performed by a mobile device (such as mobile device 108 of FIG. 1 or mobile device 200 of FIG. 2) alone or in combination with network resources (such as network equipment 110 of FIG. 1).

The method 300 may include, at 302, generating a request for measurement report. The request for measurement report may be local (such as a mobile originated location request, MOLR), for instance when an application running on the mobile device 200 requests a position of the device. Alternatively, the request for measurement report may be remote (such as a mobile terminated location request, MTLR, or a network initiated location request, NILR), for instance when the request for measurement is received at the mobile device from the network.

The method 300 may include, at 304, receiving request for measurement report. If the measurement report request is local, this may simply be routing the request internally within the mobile device to the GNSS core. If the measurement report request is remote, the location framework 212 may receive the request from the network via antenna 216 and processors 204. The request may specify that it is an MS-assisted mode request.

The method 300 may include, at 306, forwarding the request for measurement report to the NAV Engine 208.

The method 300 may include, at 308, the NAV Engine 208 activating the GNSS baseband 210, if the GNSS baseband is not already active.

The method 300 may include, at 310, forwarding, by the NAV Engine 208, the request for measure report to the GNSS baseband 210.

The method 300 may include, at 312, acquiring and tracking GNSS satellites. This may be done by the GNSS baseband 210 using the GNSS antenna 214. At 314, the method may include producing, by the GNSS baseband 210, the measurement report. The measurement report may contain pseudo-ranges measured by the GNSS baseband 210. The measurement report may also contain quality indicators calculated and/or measured by the GNSS baseband 210. The quality indicators may include, or be based on, signal to noise ratio (SNR) as well as losses (e.g., blanking periods and quality of signal or frequency lock). The quality indicators may also include satellite vehicle health indicators. These may include information sent from the satellite regarding its operational status, maintenance needs, or other indicators from the satellite regarding the reliability of its data.

At 316 the method may include downloading and parsing the satellite data blocks by the GNSS baseband 210. In many instances, rather than directly acquiring data from the GNSS satellites the mobile device 200 may receive data via the network (such as from network equipment 110). GNSS satellite data transfer rates can be slow relative to network transfer rates and thus time and resources can be conserved by downloading satellite data at network equipment 110 (which is often stationery infrastructure equipment) and then transmitting the downloaded data to the mobile device 200 as needed. Such data may be sent to the mobile device 200 over the network, as for instance when the request for measurement report is sent. Alternatively, the mobile device may request the information from the network in response to locally generated request.

The method 300 may include, at 318, the GNSS baseband 210 sending the measurement report to the NAV engine 208. At 320, the method may include sending, by the GNSS baseband 210, the parsed satellite data blocks to the NAV engine 208. At 322, the method may include comparing, by the NAV Engine 208, the quality indicators from the measurement report to threshold values. If, for example, the quality indicators do not exceed the threshold values the process ends at 324. In this instance, the system may attempt to take additional measurements until the quality indicators exceed the threshold values or the system may not take action until it receives another request for measurement report.

While embodiments describe a value exceeding a threshold as a condition precedent, it will be understood that condition precedents in other embodiments may correspond with other comparative functions. For example, in another embodiment, a value being equal to or greater than a threshold value may be a condition precedent.

If the quality indicators exceed the threshold values at 322, the method may include calculating, by the NAV Engine 208, the position and the QoP at 326. At 328, the method may include comparing, by the NAV Engine 208, the calculated QoP to a threshold value. If, for example, the QoP does not exceed the threshold value the process ends at 330. In this instance, the system may attempt to take additional measurements until the QoP exceeds the threshold value or the system may not take action until it receives another request for measurement report. If the QoP exceeds the threshold value at 328, the method may include forwarding, by the NAV Engine 208, the measurement report to the location framework 212 at 332. The method 300 may include, at 334, transmitting, by the location framework 212, the measurement report to a remote location server (such as network equipment 110 in FIG. 1) using antenna 216.

By sending the measurement report only when the QoP exceeds the threshold value, the method 300 prevents the transmission of data that will result in inaccurate or inadequate position determinations at the network equipment 110. Transmitting the measurement report consumes power and computational resources at the mobile device. Thus by eliminating the transmission of measurement reports that will not produce sufficiently accurate positions when calculated at the network equipment 110, power and computational resources may be saved at the mobile device. If the QoP is not calculated at the mobile device it is possible to send numerous measurement reports to the network equipment utilizing mobile device power and computational resources without accurately determining the position as desired. The method 300 may eliminate the transmission of inadequate measurement reports and thus save mobile device power and computational resources.

In some embodiments the QoP threshold may be included in the request for measurement report. In this way, the QoP threshold may be set based on the use case of the request. For instance, an application running on the mobile device requesting the position of the device to locate a nearby retail establishment may require a less stringent QoP than a request that seeks to establish a position for providing turn-by-turn directions. In such embodiments it may thus be possible to receive multiple requests with different QoP thresholds. For instance, a first request may be received at the mobile device with a relatively stringent QoP threshold. Subsequently, a second request may be received with a less stringent QoP threshold. In such a situation it may be possible that the measurement report is sent in response to the second request, but not in response to the first request. This may occur when the less stringent QoP of the second request can be achieved, but the more stringent QoP threshold of the first request cannot be achieved by the mobile device at that time.

The request may also include a mode of operation. The mode of operation can dictate under what circumstances the mobile device should transmit the measurement report. Under a first mode the mobile device will send any measurement report regardless of QoP. Under a second mode, the mobile device will send the measurement report continuously until the QoP is met. Under a third mode (as shown in method 300), the mobile device only sends the measurement report when the QoP exceeds the threshold value. It is also possible to include a timeout limitation such that the mobile device will attempt to reach the threshold QoP for a limited amount of time. It is also possible to send the measurement report if the time limit is reached even if the threshold QoP is not met. Under a fourth mode, the request may contain two QoP thresholds. The first may be a minimum acceptable QoP such that the mobile device will not send the measurement report unless the calculated QoP exceeds the minimum acceptable QoP. The second may be a preferred QoP that is more stringent than the minimum acceptable QoP. In this instance the mobile device may continue to calculate positions and QoP values for a fixed time period or a fixed number of attempts. If the preferred QoP is exceeded, the mobile device will transmit the measurement report. If the preferred QoP is not exceeded after the fixed time or number of attempts, the mobile device will only send the measurement report if the minimum acceptable QoP has been exceeded.

The GNSS core 202 and related functionality described herein may be implemented into a system using any suitable hardware and/or software to configure as desired. FIG. 4 illustrates, for one embodiment, an example system 400 comprising one or more processor(s) 404, system control logic 408 coupled with at least one of the processor(s) 404, system memory 412 coupled with system control logic 408, non-volatile memory (NVM)/storage 416 coupled with system control logic 408, a network interface 420 coupled with system control logic 408, and input/output (I/O) devices 432 coupled with system control logic 408.

The processor(s) 404 may include one or more single-core or multi-core processors. The processor(s) 404 may include any combination of general-purpose processors and dedicated processors (e.g., graphics processors, application processors, baseband processors, etc.). Processor(s) 404 may incorporate an applications processor, a graphics processor, and a modem (such as an LTE modem) or any combination of such elements. For instance, in some embodiments, processor(s) 404 may include an integrated applications processor and LTE modem. In one embodiment, processor(s) 404 may be an Intel® XMM™ 7160 chip.

System control logic 408 for one embodiment may include any suitable interface controllers to provide for any suitable interface to at least one of the processor(s) 404 and/or to any suitable device or component in communication with system control logic 408.

System control logic 408 for one embodiment may include one or more memory controller(s) to provide an interface to system memory 412. System memory 412 may be used to load and store data and/or instructions, e.g., GNSS logic 424. System memory 412 for one embodiment may include any suitable volatile memory, such as suitable dynamic random access memory (DRAM), for example.

NVM/storage 416 may include one or more tangible, non-transitory computer-readable media used to store data and/or instructions, e.g., GNSS logic 424. NVM/storage 416 may include any suitable non-volatile memory, such as flash memory, for example, and/or may include any suitable non-volatile storage device(s), such as one or more hard disk drive(s) (HDD(s)), one or more compact disk (CD) drive(s), and/or one or more digital versatile disk (DVD) drive(s), for example.

The NVM/storage 416 may include a storage resource physically part of a device on which the system 400 is installed or it may be accessible by, but not necessarily a part of, the device. For example, the NVM/storage 416 may be accessed over a network via the network interface 420 and/or over Input/Output (I/O) devices 432.

The GNSS logic 424 may include instructions that, when executed by one or more of the processors 404, cause the system 400 to perform operations associated with the components of the GNSS core 202 as described with respect to the above embodiments. In various embodiments, the GNSS logic 424 may include hardware, software, and/or firmware components that may or may not be explicitly shown in system 400. Alternatively, GNSS core 202 may be a separate unit included in the Input/Output devices 432.

Network interface 420 may have a transceiver 422 to provide a radio interface for system 400 to communicate over one or more network(s) and/or with any other suitable device. In various embodiments, the transceiver 422 may be integrated with other components of system 400. For example, the transceiver 422 may include a processor of the processor(s) 404, memory of the system memory 412, and NVM/Storage of NVM/Storage 416. Network interface 420 may include any suitable hardware and/or firmware. Network interface 420 may include a plurality of antennas to provide a multiple input, multiple output radio interface. Network interface 420 for one embodiment may include, for example, a wired network adapter, a wireless network adapter, a telephone modem, and/or a wireless modem.

For one embodiment, at least one of the processor(s) 404 may be packaged together with logic for one or more controller(s) of system control logic 408. For one embodiment, at least one of the processor(s) 404 may be packaged together with logic for one or more controllers of system control logic 408 to form a System in Package (SiP). For one embodiment, at least one of the processor(s) 404 may be integrated on the same die with logic for one or more controller(s) of system control logic 408. For one embodiment, at least one of the processor(s) 404 may be integrated on the same die with logic for one or more controller(s) of system control logic 408 to form a System on Chip (SoC).

In various embodiments, the I/O devices 432 may include user interfaces designed to enable user interaction with the system 400, peripheral component interfaces designed to enable peripheral component interaction with the system 400, and/or sensors designed to determine environmental conditions and/or location information related to the system 400.

In various embodiments, the user interfaces could include, but are not limited to, a display (e.g., a liquid crystal display, a touch screen display, etc.), speakers, a microphone, one or more cameras (e.g., a still camera and/or a video camera), a flashlight (e.g., a light emitting diode flash), and a keyboard.

In various embodiments, the peripheral component interfaces may include, but are not limited to, a non-volatile memory port, a universal serial bus (USB) port, an audio jack, an Ethernet connection, and a power supply interface.

In various embodiments, the sensors may include, but are not limited to, a gyro sensor, an accelerometer, a proximity sensor, an ambient light sensor, and a positioning unit. The positioning unit may also be part of, or interact with, the network interface 420 to communicate with components of a positioning network, e.g., GNSS satellites. In some embodiments, the GNSS core 202 is part of, or makes up the positioning unit. In other embodiments the functions of the GNSS core may be performed by a combination of the positioning unit and logic running on one of the processor(s) 404.

In various embodiments, the system 400 may be a mobile computing device such as, but not limited to, a laptop computing device, a tablet computing device, a netbook, a smartphone, etc. In various embodiments, system 400 may have more or less components, and/or different architectures.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims and the equivalents thereof.

Various embodiments may include any suitable combination of the above-described embodiments including alternative (or) embodiments of embodiments that are described in conjunctive form (and) above (e.g., the “and” may be “and/or”). Furthermore, some embodiments may include one or more articles of manufacture (e.g., non-transitory computer-readable media) having instructions, stored thereon, that when executed result in actions of any of the above-described embodiments. Moreover, some embodiments may include apparatuses or systems having any suitable means for carrying out the various operations of the above-described embodiments.

The above description of illustrated implementations, including what is described in the Abstract, is not intended to be exhaustive or to limit the embodiments of the present disclosure to the precise forms disclosed. While specific implementations and examples are described herein for illustrative purposes, various equivalent modifications are possible within the scope of the present disclosure, as those skilled in the relevant art will recognize.

These modifications may be made to embodiments of the present disclosure in light of the above detailed description. The terms used in the following claims should not be construed to limit various embodiments of the present disclosure to the specific implementations disclosed in the specification and the claims. Rather, the scope is to be determined entirely by the following claims, which are to be construed in accordance with established doctrines of claim interpretation.

### EXAMPLES

Some non-limiting examples are provided below.

Example 1 includes an apparatus for use in mobile station (MS)-assisted position measurement, the apparatus comprising: transceiver circuitry to communicate with a network server; and location circuitry to: receive a request for measurement report; gather data in response to the request for measurement report; generate a measurement report based on the gathered data; calculate a quality-of-position (QOP) value based on the gathered data; compare the QOP value to a threshold value; and provide the measurement report to the transceiver circuitry for transmission to the network server based on said comparison of the QOP value to the threshold value.

Example 2 includes the apparatus of claim 1, wherein: the request for measurement report includes the threshold value.

Example 3 includes the apparatus of claim 1, wherein: the request for measurement report includes an indication of a mode of operation.

Example 4 includes the apparatus of claim 1, wherein: the request for measurement report is a first request for measurement report and when processing the first request for measurement report the location circuitry operates in a first mode under which the location circuitry is to provide the measurement report to the transceiver circuitry only if the QOP value exceeds the threshold value; and wherein the location circuitry is to receive a second request for measurement report indicating a mode of operation including one of: the first mode; a second mode under which the location circuitry is to provide the measurement report to the transceiver circuit regardless of the calculated QOP value; and a third mode under which the location circuitry is to provide the measurement report to the transceiver circuitry repeatedly until the calculated QOP value exceeds the threshold value.

Example 5 includes the apparatus of any of claim 1-4, wherein: the request for measurement report is a first request for measurement report and includes the threshold value, which is a first threshold value; and wherein the location circuitry is to receive a second request for measurement report including a second threshold value that is different from the first threshold value.

Example 6 includes the apparatus of any of claim 1-4, wherein: the location circuitry is included in integrated circuitry also providing LTE modem functionality.

Example 7 includes an apparatus for use in mobile station (MS)-assisted position measurement, the apparatus comprising: location framework circuitry to: communicate with a network server; global navigation satellite system (GNSS) baseband circuitry to: receive data from a satellite vehicle; and NAV engine circuitry to: calculate a position based on the received data; calculate a quality-of-position (QOP) value that corresponds to the calculated position; compare the QOP value to a threshold value; and provide the calculated position to the location framework circuitry for transmission to the network server based on said comparison of the QOP value to the threshold value.

Example 8 includes the apparatus of claim 7, wherein the location framework circuitry is to receive a request for measurement report from a network server.

Example 9 includes the apparatus of claim 8, wherein the request for measurement report defines the threshold value.

Example 10 includes the apparatus of any of claim 7-9, wherein the location framework circuitry is to receive the measurement report from the NAV engine circuitry and to transmit the measurement report to the network server.

Example 11 includes the apparatus of any of claim 7-9, wherein the location framework circuitry is coupled with a first antenna and the GNSS baseband circuitry is coupled with a second antenna.

Example 12 includes an apparatus for generating a request for measurement report comprising: measurement report request circuitry to: generate a request for measurement report including a quality-of-position (QOP) threshold value; and communication circuitry to: send the request for measurement to other circuitry for processing.

Example 13 includes the apparatus of claim 12, wherein the measurement report request circuitry is to include an indication of a mode of operation in the request for measurement report.

Example 14 includes the apparatus of claim 13 wherein the indication of a mode of operation identifies at least one of: a first mode of operation under which the position determination circuitry is to compare the calculated QOP value to the threshold QOP value and send the measurement report to a remote network server based on the comparison; or a second mode of operation under which the position determination circuitry is to send at least one measurement report to a remote network server regardless of the calculated QOP value.

Example 15 includes apparatus of any of claim 12-14, wherein the apparatus is located in a node of a network.

Example 16 includes the apparatus of claim 15, wherein communication circuitry is to send the request for measurement to other circuitry for processing by transmitting the request for measurement report to a mobile device over the network.

Example 17 includes the apparatus of any of claim 12-14, wherein the apparatus is located in a mobile device.

Example 18 includes the apparatus of claim 17, wherein communication circuitry is to send the request for measurement to other circuitry for processing by routing the request for measurement report to other circuitry within the mobile device.

Example 19 includes one or more tangible computer-readable media having instructions, stored thereon, that when executed cause a position determination device to: receive a request for measurement report; generate a measurement report; calculate a quality-of-position (QOP) value compare the QOP value to a threshold QOP value; and transmit the measurement report to a network server based on the comparison.

Example 20 includes the one or more media of claim 18, wherein the instructions, when executed, cause the position determination device to determine the threshold QOP value based on information contained in the request for measurement report.

Example 21 includes the one or more media of claim 18, wherein the instructions, when executed, cause the position determination device to determine that measurement quality indicators exceed quality thresholds prior to calculating the QOP value.

Example 22 includes the one or more media of any of claim 18-20, wherein the instructions, when executed, cause the position determination device to repeatedly generate measurement reports and calculate QOP values until the QOP value meets the threshold.

Example 23 includes the one or more media of claim 21 wherein the repeated generation of measurement reports and calculation of QOP values is limited by a timeout parameter or an iteration counter.

Example 24 includes the one or more media of any of claim 18-20, wherein the instructions, when executed, cause the position determination device to transmit an error message to the network server if the QOP value does not meet the threshold.

1-24. (canceled)

25. An apparatus for use in mobile station (MS)-assisted position measurement, the apparatus comprising:
transceiver circuitry to communicate with a network server; and
location circuitry to:
receive a request for measurement report;
gather data in response to the request for measurement report;
generate a measurement report based on the gathered data;
calculate a quality-of-position (QOP) value based on the gathered data;
compare the QOP value to a threshold value; and
provide the measurement report to the transceiver circuitry for transmission to the network server based on said comparison of the QOP value to the threshold value.

26. The apparatus of claim 25, wherein:
the request for measurement report includes the threshold value.

27. The apparatus of claim 25, wherein:
the request for measurement report includes an indication of a mode of operation.

28. The apparatus of claim 25, wherein:
the request for measurement report is a first request for measurement report and when processing the first request for measurement report the location circuitry operates in a first mode under which the location circuitry is to provide the measurement report to the transceiver circuitry only if the QOP value exceeds the threshold value; and
wherein the location circuitry is to receive a second request for measurement report indicating a mode of operation including one of:
the first mode;
a second mode under which the location circuitry is to provide the measurement report to the transceiver circuit regardless of the calculated QOP value; and
a third mode under which the location circuitry is to provide the measurement report to the transceiver circuitry repeatedly until the calculated QOP value exceeds the threshold value.

29. The apparatus of claim 25, wherein:
the request for measurement report is a first request for measurement report and includes the threshold value, which is a first threshold value; and
wherein the location circuitry is to receive a second request for measurement report including a second threshold value that is different from the first threshold value.

30. The apparatus of any claim 25, wherein:
the location circuitry is included in integrated circuitry also providing LTE modem functionality.

31. An apparatus for use in mobile station (MS)-assisted position measurement, the apparatus comprising:
location framework circuitry to:
communicate with a network server;
global navigation satellite system (GNSS) baseband circuitry to:
receive data from a satellite vehicle; and
NAV engine circuitry to:
calculate a position based on the received data;
calculate a quality-of-position (QOP) value that corresponds to the calculated position;
compare the QOP value to a threshold value; and
provide the calculated position to the location framework circuitry for transmission to the network server based on said comparison of the QOP value to the threshold value.

32. The apparatus of claim 31, wherein the location framework circuitry is to receive a request for measurement report from a network server.

33. The apparatus of claim 32, wherein the request for measurement report defines the threshold value.

34. The apparatus of claim 31, wherein the location framework circuitry is to receive the measurement report from the NAV engine circuitry and to transmit the measurement report to the network server.

35. The apparatus of claim 31, wherein the location framework circuitry is coupled with a first antenna and the GNSS baseband circuitry is coupled with a second antenna.

36. An apparatus for generating a request for measurement report comprising:
measurement report request circuitry to:
generate a request for measurement report including a quality-of-position (QOP) threshold value; and
communication circuitry to:
send the request for measurement to other circuitry for processing.

37. The apparatus of claim 36, wherein the measurement report request circuitry is to include an indication of a mode of operation in the request for measurement report.

38. The apparatus of claim 37 wherein the indication of a mode of operation identifies at least one of:
a first mode of operation under which the position determination circuitry is to compare the calculated QOP value to the threshold QOP value and send the measurement report to a remote network server based on the comparison; or
a second mode of operation under which the position determination circuitry is to send at least one measurement report to a remote network server regardless of the calculated QOP value.

39. The apparatus of claim 36, wherein the apparatus is located in a node of a network.

40. The apparatus of claim 39, wherein communication circuitry is to send the request for measurement to other circuitry for processing by transmitting the request for measurement report to a mobile device over the network.

41. The apparatus of claim 36, wherein the apparatus is located in a mobile device.

42. The apparatus of claim 41, wherein communication circuitry is to send the request for measurement to other circuitry for processing by routing the request for measurement report to other circuitry within the mobile device.

43. One or more tangible computer-readable media having instructions, stored thereon, that when executed cause a position determination device to:
receive a request for measurement report;
generate a measurement report;
calculate a quality-of-position (QOP) value
compare the QOP value to a threshold QOP value; and
transmit the measurement report to a network server based on the comparison.

44. The one or more media of claim 43, wherein the instructions, when executed, cause the position determination device to determine the threshold QOP value based on information contained in the request for measurement report.

45. The one or more media of claim 43, wherein the instructions, when executed, cause the position determination device to determine that measurement quality indicators exceed quality thresholds prior to calculating the QOP value.

46. The one or more media of claim 43, wherein the instructions, when executed, cause the position determination device to repeatedly generate measurement reports and calculate QOP values until the QOP value meets the threshold.

47. The one or more media of claim 43 wherein the repeated generation of measurement reports and calculation of QOP values is limited by a timeout parameter or an iteration counter.

48. The one or more media of claim 43, wherein the instructions, when executed, cause the position determination device to transmit an error message to the network server if the QOP value does not meet the threshold.
